(19) United States
(12) Patent Application Publication
(10) Pub. No.: US 2025/0344632 A1
(43) Pub. Date: Nov. 13, 2025

(54) Distributing Unit for an Agricultural Distributor and Method for Operating a Distributing Unit

(71) Applicant: Amazonen-Werke H. Dreyer SE & Co., KG, Hasbergen (DE)

(72) Inventors: Roland ARNOLD, Ganderkesee (DE); Christian HENKE, Burgwedel (DE); Florenz HILBERT, Emsdetten (DE); Jens KOCH, Uelzen (DE)

(73) Assignee: Amazonen-Werke H. Dreyer SE & Co., KG, Hasbergen (DE)

(21) Appl. No.: 18/867,925

(22) PCT Filed: May 15, 2023
(86) PCT No.: PCT/EP2023/062892

§ 371 Date: Nov. 21, 2024

(30) Foreign Application Priority Data
May 23, 2022 (DE) 10 2022 112 842.3

(51) Int. Cl. A01C 7/20; A01C 7/06; A01C 7/10

(52) U.S. Cl. CPC A01C 7/20; A01C 7/06; A01C 7/102

(57) ABSTRACT

A distributing unit for an agricultural distributor, having a fertilizer-depositing device for depositing fertilizer on agricultural land, and having a seed-depositing device for depositing seed on the agricultural land, wherein the fertilizer-depositing device and the seed-depositing device are fastened on a carrier mechanism, and the carrier mechanism allows a change in the relative position between the fertilizer-depositing device and the seed-depositing device.

### CROSS REFERENCE TO RELATED APPLICATIONS

The present application claims priority under 35 U.S.C. § 365 to PCT/EP2023/062892 filed on May 15, 2023 and under 35 U.S.C. § 119 (a) to German Application No. 10 2022 12 842.3 filed on May 23, 2022, both of which are incorporate by reference in their entireties.

### TECHNICAL FIELD

The disclosure relates to a distributing unit for an agricultural distributor and a method for operating a distributing unit.

### BACKGROUND

For a combined depositing of fertilizer and seed, the distributing units of agricultural distributors can be equipped with both a fertilizer-depositing device and a seed-depositing device. The fertilizer-depositing device and the seed-depositing device are usually fastened on a common carrier mechanism, wherein the carrier mechanism, due to its structure, allows a change in the relative position between the fertilizer-depositing device and the seed-depositing device.

From document US 2015/0230391 A1, for example, a distributing unit with a fertilizer-depositing device for depositing fertilizer and a seed-depositing device for depositing seeds is known, wherein the difference in height between the fertilizer-depositing device and the seed-depositing device can be determined in order to achieve a sowing depth that is as uniform as possible and aimed for.

Document DE 10 2010 015 166 B4 discloses an angle adjustment for a seed-dispensing line, wherein the adjustment is dependent on the driving speed and the properties of the seed.

In a plurality of applications, however, it is necessary to maintain a specific longitudinal distance between fertilizer and seed on the agricultural land, wherein the longitudinal distance between the deposited fertilizer and the deposited seed can change due to a varying relative position between the fertilizer-depositing device and the seed-depositing device.

### SUMMARY

The problem underlying the disclosure thus consists in enabling the intended longitudinal distance between the deposited fertilizer and the deposited seed on the agricultural land to be maintained in the case of distributing units having a carrier mechanism that allows the relative position between the fertilizer-depositing device and the seed-depositing device to be changed.

The problem is solved by a distributing unit of the type mentioned introductorily, wherein the distributing unit according to the disclosure has a position-detecting system which is adapted to sensor-based detect a relative position between the fertilizer-depositing device and the seed-depositing device, which influences the longitudinal distance of the fertilizer deposited on the agricultural land and the seed deposited on the agricultural land.

Using the sensor-based detection of the relative position between the fertilizer-depositing device and the seed-depositing device, it can be determined whether the longitudinal distance between the deposited fertilizer and the deposited seed resulting from the relative position between the fertilizer-depositing device and the seed-depositing device lies within a tolerance range. If the longitudinal distance between the deposited fertilizer and the deposited seed lies outside the tolerance range, measures are required by which the longitudinal distance between the deposited fertilizer and the deposited seed is corrected. These measures may, for example, relate to a change in the position and/or location of the fertilizer-depositing device and/or the seed-depositing device. Alternatively or additionally, the operation of a fertilizer-metering device and/or a seed-metering device of the distributing unit can be adapted at least temporarily, so that, for example, the longitudinal distance between the seeds metered individually by the seed-metering device and the fertilizer portions produced by the fertilizer-metering device is corrected. Thus, by means of the position-detecting system, fertilizer depositing and seed depositing can be coordinated with each other so that an intended longitudinal distance between the deposited fertilizer and the deposited seed is maintained or, in particular, re-established despite varying relative positions.

The fertilizer-depositing device may be a fertilizer coulter. The fertilizer coulter may be a disc coulter and/or comprise one or more coulter discs and/or a fertilizer-depositing line.

The seed-depositing device may be a sowing coulter. The sowing coulter may be a disc coulter and/or comprise one or more coulter discs and/or a seed-depositing line.

In a preferred embodiment of the distributing unit according to the disclosure, the position-detecting system has at least one sensor and an electronic data-processing device, wherein the electronic data-processing device is adapted to evaluate sensor data from the sensor for detecting the relative position between the fertilizer-depositing device and the seed-depositing device. The sensor data need not necessarily be distance data. The sensor data may be data concerning the position and/or alignment of the fertilizer-depositing device and/or the position and/or alignment of parts connected to the fertilizer-depositing device, for example parts of the carrier mechanism. The sensor data may also be data concerning the position and/or alignment of the seed-depositing device and/or the position and/or alignment of parts connected to the seed-depositing device, for example parts of the carrier mechanism. Such data allows conclusions to be drawn about the relative position of the fertilizer-depositing device and the seed-depositing device and can be processed by the data-processing device in this regard.

In a preferred embodiment of the distributing unit according to the disclosure, the fertilizer-depositing device has a fertilizer-dispensing opening for dispensing fertilizer in the direction of the ground of the agricultural land. Alternatively or additionally, the seed-depositing device can have a seed-dispensing opening for dispensing seeds in the direction of the ground of the agricultural land. The carrier mechanism preferably allows the longitudinal distance between the fertilizer-dispensing opening and the seed-dispensing opening to be changed. The relative position between the fertilizer-depositing device and the seed-depositing device, which can be detected by the sensor-based position-detecting system, preferably includes the longitudinal distance between the fertilizer-dispensing opening and the seed-dispensing opening. The position-detecting system is preferably adapted to determine the position of the fertilizer-dispensing opening and the position of the seed-dispensing opening and/or the longitudinal offset of the fertilizer-dispensing opening and/or seed-dispensing opening from a starting position. The fertilizer-dispensing opening predetermines, in particular by its position, the time of dispensing of the fertilizer. The seed-dispensing opening predetermines, in particular by its position, the time of dispensing of the seed.

In another preferred embodiment of the distributing unit according to the disclosure, the carrier mechanism allows the alignment of the fertilizer-depositing device to be changed, wherein the relative position between the fertilizer-depositing device and the seed-depositing device, which can be sensor-based detected by the position-detecting system, comprises the alignment of the fertilizer-depositing device and/or the relative alignment of the fertilizer-depositing device and the seed-depositing device. Alternatively or additionally, the carrier mechanism allows the alignment of the seed-depositing device to be changed, wherein the relative position between the fertilizer-depositing device and the seed-depositing device, which can be sensor-based detected by the position-detecting system, comprises the alignment of the seed-depositing device and/or the relative alignment of the seed-depositing device and the fertilizer-depositing device. By changing the inclination of the fertilizer-depositing device relative to the ground, the direction of dispensing of the fertilizer and thus also the longitudinal distance between the deposited fertilizer and the deposited seed is changed. By changing the inclination of the seed-depositing device, the direction of dispensing of the seed and thus also the longitudinal distance between the deposited fertilizer and the deposited seed is changed. The detection of the alignment of the fertilizer-depositing device and/or the seed-depositing device can therefore be used to determine whether the longitudinal distance between the deposited fertilizer and the deposited seed is within a tolerance range.

Furthermore, a distributing unit according to the disclosure is preferred in which the carrier mechanism has an attachment part by means of which the carrier mechanism can be fastened to a unit carrier, in particular a cross beam, of the distributor. The carrier mechanism preferably comprises a deflection mechanism that influences the seed deposition and by means of which the seed-depositing device can be deflected in relation to the attachment part of the carrier mechanism, in particular in order to follow the contours of the ground of the agricultural land. The deflection mechanism can, for example, be a parallelogram linkage. By means of the deflection mechanism, the seed-depositing device can be deflected up and down in the vertical direction, so that an intended depth of seed deposition can be maintained even in the case of uneven terrain with crests and hollows.

In another preferred embodiment of the distributing unit according to the disclosure, at least one sensor of the position-detecting system is adapted to detect a deflection state of the deflection mechanism influencing the seed deposition. The sensor of the position-detecting system can be a position sensor, in particular an angle sensor. The sensor is preferably arranged on the deflection mechanism influencing the seed deposition. Alternatively, the sensor can detect the ground contour, for example optically, so that the deflection of the deflection mechanism can be calculated. The electronic data-processing device is preferably adapted to calculate the relative position of the fertilizer-depositing device and the seed-depositing device on the basis of the state of deflection of the deflection mechanism influencing the seed deposition. The electronic data-processing device is preferably adapted to calculate the longitudinal distance between the fertilizer-dispensing opening and the seed-dispensing opening on the basis of the state of deflection of the deflection mechanism influencing the seed deposition.

Furthermore, a distributing unit according to the disclosure is preferred in which the carrier mechanism comprises a deflection mechanism influencing the fertilizer deposition. By means of the deflection mechanism influencing the fertilizer deposition, the fertilizer-depositing device can be deflected with respect to the attachment part of the carrier mechanism, in particular for following the ground contour of the agricultural land. The deflection mechanism influencing the fertilizer-depositing device preferably comprises a plurality of, for example two, links that are connected to one another in an articulated manner, wherein one link is articulated to the attachment part and one link is articulated to the fertilizer-depositing device.

The distributing unit according to the disclosure is preferably further developed in that at least one sensor of the position-detecting system is adapted to detect a deflection state of the deflection mechanism influencing the fertilizer deposition. The sensor of the position-detecting system can be a position sensor, in particular an angle sensor. The sensor is preferably arranged on the deflection mechanism influencing the fertilizer deposition. Alternatively, the sensor can detect the ground contour, for example optically, so that the deflection of the deflection mechanism can be calculated. The electronic processing device is preferably adapted to calculate the relative position between the fertilizer-depositing device and the seed-depositing device on the basis of the deflection state of the deflection mechanism influencing the fertilizer deposition. The electronic data-processing device is preferably adapted to calculate the longitudinal distance between the fertilizer-dispensing opening and the seed-dispensing opening on the basis of the deflection state of the deflection mechanism influencing the fertilizer deposition.

Furthermore, a distributing unit according to the disclosure is preferred in which the deflection mechanism influencing the seed deposition and the deflection mechanism influencing the fertilizer deposition are mechanically coupled to each other. The deflection mechanism influencing the seed deposition and the deflection mechanism influencing the fertilizer deposition are preferably coupled to each other via a coupling rod. The deflection of the deflection mechanism influencing the seed deposition preferably results in a deflection of the deflection mechanism influencing the fertilizer deposition. Conversely, the deflection of the deflection mechanism influencing the fertilizer deposition can result in a deflection of the deflection mechanism influencing the seed deposition. Preferably, the deflection mechanism influencing the fertilizer deposition has a free wheel relative to the deflection mechanism influencing the seed deposition, such that a deflection of the deflection mechanism influencing the seed deposition results in a deflection of the deflection mechanism influencing the fertilizer deposition, but not the other way around.

The deposition depth of the fertilizer can be changed by means of a movable adjusting element of the distributing unit. The adjusting element can be configured as a rotatable eccentric. The adjusting element preferably connects the deflection mechanism influencing the seed deposition with the coupling rod. The upper articulation point of the coupling rod can be changed by twisting the adjusting element, so that the distance between the fertilizer-depositing device and the deflection mechanism influencing the seed-depositing device is changed. Several deposition depths of the fertilizer can be set via the adjusting element.

In a further preferred embodiment of the distributing unit according to the disclosure, the deflection mechanism influencing the fertilizer deposition comprises a suspension, in particular a leaf suspension. The suspension can connect an attachment part of the carrier mechanism, by means of which the carrier mechanism can be fastened on a unit carrier, in particular a cross beam, to the fertilizer-depositing device. The suspension preferably allows the fertilizer-depositing device to be compressed and/or to rebound, in particular in the vertical direction.

The distributing unit according to the disclosure is preferably further developed in that the position-detecting system is adapted to calculate a smooth-running value which characterizes the smooth running of the fertilizer-depositing device, in particular on the basis of changes in the position of the fertilizer-depositing device determined over a period of time and/or on the basis of the relative positions of the fertilizer-depositing device and the seed-depositing device determined over a period of time. Alternatively or additionally, the position-detecting system can be adapted to calculate a smooth-running value which characterizes the smooth running of the seed-depositing device, in particular on the basis of changes in the position of the seed-depositing device and/or on the basis of the relative positions between the fertilizer-depositing device and the seed-depositing device, determined over a period of time. On the basis of the respective smooth-running values, it can be determined whether the smooth running of the fertilizer-depositing device and the smooth running of the seed-depositing device are within a tolerance range. If the smooth running of the fertilizer-depositing device and/or the smooth running of the seed-depositing device are outside of a tolerance range, measures can be initiated that result in an improvement or increase in smooth running.

In a further preferred embodiment, the distributing unit according to the disclosure has a fertilizer-metering device which is adapted to meter the fertilizer to be deposited. The fertilizer-metering device may be a fertilizer portioner which is adapted to portion the fertilizer to be deposited, that is, to combine the fertilizer to be deposited into accumulations of several grains, thus portions, and to dispense them as such in a bundled manner at a predetermined time interval, so that a dispensing cycle is created in contrast to the usual continuous deposition of fertilizer in a continuous band. Furthermore, the distributing unit can have a seed-metering device which is adapted to meter the seed to be deposited. In particular, the seed-metering device is a seed-separating device which is adapted to separate the seed to be deposited. Preferably, the distributing unit has a control device, wherein the control device can be adapted to control the operation of the fertilizer-metering device as a function of the relative position between the fertilizer-depositing device and the seed-depositing device. Alternatively or additionally, the control device can be adapted to control the operation of the seed-metering device depending on the relative position of the fertilizer-depositing device and the seed-depositing device. Alternatively or additionally, the control device can be adapted to coordinate the operation of the fertilizer-metering device and the operation of the seed-metering device with each other, depending on the relative position between the fertilizer-depositing device and the seed-depositing device. By controlling the operation of the fertilizer-metering device and/or the seed-metering device as a function of the relative position of the fertilizer-depositing device and the seed-depositing device, a desired depositing relationship between fertilizer and seed on the ground of the agricultural land can be implemented, even if the fertilizer-depositing device and/or the seed-depositing device is/are deflected in such a way that the longitudinal distance between the fertilizer-depositing device and the seed-depositing device changes. In this way, synchronized fertilizer and seed depositing can be implemented by means of coordinated dispensing times for fertilizer and seed, even if a contour adaptation of the fertilizer-depositing device and/or the seed-depositing device to the ground is carried out. The fertilizer-metering device can comprise a rotatably drivable portioning element, for example a portioning wing. Controlling the operation of the fertilizer-metering device can lead to a temporary speed adjustment, for example, to a temporary acceleration or deceleration, at the portioning element, so that the frequency at which fertilizer portions are provided is temporarily changed. The seed-metering device can comprise a rotatably drivable separating element, for example a separating disc. Controlling the operation of the seed-metering device can lead to a temporary speed adjustment, for example to a temporary acceleration or deceleration, at the separating element, so that the frequency at which separated seeds are provided is temporarily changed.

In another preferred embodiment of the distributing unit according to the disclosure, the fertilizer-depositing device comprises a fertilizer-depositing line and/or a fertilizer-dispensing opening. Alternatively or additionally, the seed-depositing device comprises a seed-depositing line and/or a seed-dispensing opening. The control device can be adapted to control a positioning drive to change the position of the fertilizer-dispensing opening and/or the alignment of the fertilizer-depositing line as a function of the relative position between the fertilizer-depositing line and the seed-depositing device. Alternatively or additionally, the control device can be adapted to control a positioning drive to change the position of the seed-dispensing opening and/or the alignment of the seed-depositing line as a function of the relative position between the fertilizer-depositing device and the seed-depositing device. The positioning drive can be an electric motor. The positioning drive can be a linear motor. The control device can be adapted to control the pressing force of the fertilizer-depositing device and/or the seed-depositing device on the ground as a function of the relative position between the fertilizer-depositing device and the seed-depositing device, so that smooth running is improved.

The problem underlying the disclosure is further solved by a method of the type mentioned introductorily, wherein, in the context of the method according to the disclosure, a change in the relative position between the fertilizer-depositing device and the seed-depositing device is detected by means of a position-detecting system. A control device then controls the operation of a fertilizer-metering device of the distributing unit, which is adapted to meter fertilizer to be deposited, as a function of the detected relative position between the fertilizer-depositing device and the seed-depositing device. In particular, the fertilizer-metering device controlled by the control device is a fertilizer portioner that is adapted to portion fertilizer to be deposited. Alternatively or additionally, the control device controls the operation of a seeds-metering device of the distributing unit, which is adapted to meter seeds to be deposited, as a function of the detected relative position between the fertilizer-depositing device and the seed-depositing device. The seed metering device controlled by the control device is preferably a seed-separating device which is adapted to separate seeds to be deposited.

In a preferred embodiment of the method according to the disclosure, the control device controls a position drive of the distributing unit to change the position of a fertilizer-dispensing opening of the distributing unit and/or the alignment of the fertilizer-depositing line of the distributing unit as a function of the detected relative position between the fertilizer-depositing device and the seed-depositing device. Alternatively or additionally, the control device controls a positioning drive of the distributing unit to change the position of a seed-dispensing opening of the distributing unit and/or the alignment of a seed-depositing line of the distributing unit, as a function of the detected relative position between the fertilizer-depositing device and the seed-depositing device.

### BRIEF DESCRIPTION OF THE DRAWINGS

Preferred embodiments of the disclosure are explained and described in more detail below with reference to the accompanying drawings. It is shown by:

FIG. 1 an embodiment of the distributing unit according to the disclosure in a schematic side view;

FIG. 2 the deflection mechanism influencing the seed deposition of the distributing unit shown in FIG. 1 in a schematic side view;

FIG. 3 the distributing unit shown in FIG. 1 while driving over a hollow in the ground of the agricultural land;

FIG. 4 the distributing unit shown in FIG. 1 while driving over a crest in the ground of the agricultural land;

FIG. 5 an embodiment of the distributing unit according to the disclosure in a schematic side view, wherein a first deposition depth is set on the fertilizer-depositing device;

FIG. 6 the distributing unit shown in FIG. 5 in a schematic side view, wherein a second deposition depth is set on the fertilizer-depositing device;

FIG. 7 the distributing unit shown in FIG. 5 in a schematic side view, wherein a third deposition depth is set on the fertilizer-depositing device;

FIG. 8 a further embodiment of the distributing unit according to the disclosure in a schematic side view;

FIG. 9 the deflection mechanism influencing the seed deposition of the distributing unit shown in FIG. 8 in a schematic side view;

FIG. 10 the distributing unit shown in FIG. 8 while driving over a crest in the ground of the agricultural land; and

FIG. 11 the distributing unit shown in FIG. 8 while driving over a hollow in the ground of the agricultural land.

### DETAILED DESCRIPTION

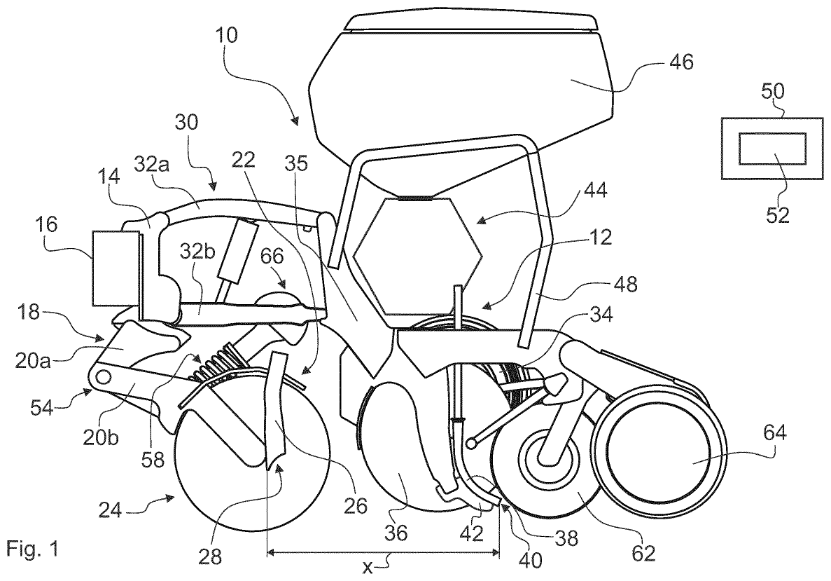

FIG. 1 shows a distributing unit (10) of an agricultural distributor, with which fertilizer and seeds can be distributed over agricultural land. Agricultural distributors usually have several distributing units 10 arranged next to each other transversely to the direction of travel, wherein each distributing unit is assigned, for example, to a row so that the fertilizer and the seed can be distributed in a row-related manner on the agricultural land. For this reason, corresponding distributing units 10 are also referred to as row units.

The distributing unit 10 includes a carrier mechanism 12. The carrier mechanism 12 includes an attachment part 14, by means of which the carrier mechanism 12 is fastened on a unit carrier 16 of the distributor. The unit carrier 16 is a cross beam running transversely to the direction of travel, on which several distributing units 10 can be fastened.

The carrier mechanism 12 comprises a deflection mechanism 18 with two links 20a, 20b connected to one another in an articulated manner, wherein the link 20a is articulated to the attachment part 14. A fertilizer-depositing device 22 is attached to the link 20b, which serves to deposit fertilizer on the agricultural land. The fertilizer-depositing device 22 is a fertilizer coulter and comprises two coulter discs 24, wherein in this representation the front coulter disc 24 is disassembled so that the view to a fertilizer-depositing line 26 arranged between the coulter discs 24 is revealed. Fertilizer to be deposited can be supplied to the fertilizer-depositing line 26, which is dispensed via the fertilizer-dispensing opening 28 of the fertilizer-depositing line 26 in the direction of the ground B of the agricultural land. The fertilizer-depositing line 26 can be connected to a fertilizer-metering device for metering the fertilizer to be deposited. The fertilizer-metering device may, for example, be a fertilizer distributor that meters the fertilizer so that fertilizer portions can be deposited on the agricultural land via the fertilizer-depositing line 26. Fertilizer portions are accumulations consisting of several fertilizer grains that can be formed to be deposited in a bundled manner on the agricultural land. Thus, a dispensing cycle is created between the individual fertilizer portions, in contrast to the previously common continuous deposition of fertilizer in the form of a band, where a varying relative position between the fertilizer-depositing device and the seed-depositing device is insignificant.

The carrier mechanism 12 also includes a deflection mechanism 30, wherein the deflection mechanism 30 is configured as a parallelogram linkage with an upper link 32a and a lower link 32b. The links 32a, 32b of the deflection mechanism 30 are connected in an articulated manner on one side to the attachment part 14 and on the other side in an articulated manner to the carrier part 35. A seed-depositing device 34 in the form of a sowing coulter is attached to the carrier part 35. The seed-depositing device 34 serves to deposit seeds on agricultural land and comprises two coulter discs 36 and a seed-depositing device 38 arranged between the coulter discs 36. Separated seeds are dispensed onto the agricultural land via the seed-dispensing opening 40 of the seed-depositing line 38. In the direction of travel in front of the seed-dispensing opening 40, the seed-depositing device 34 comprises a furrow former 42, which serves to form the deposition furrow opened by the coulter discs 36.

The fertilizer-depositing device 22 can be deflected by means of the deflection mechanism 18 in order to follow the ground contours of the agricultural land with respect to the attachment part 14 of the carrier mechanism 12. By means of the deflection mechanism 30, the seed-depositing device 34 can be deflected in order to follow the ground contours of the agricultural land with respect to the attachment part 14 of the carrier mechanism 12.

The seed grains are separated by the seed-metering device 44, which is configured as a seed-separating device. The seed-metering device 44 can comprise a rotatably driven separating element, for example a separating disc, wherein seed-receiving recesses in the separating disc are used to separate the seed grains. The seed-metering device 44 is loaded with seed from the storage container 46, wherein the storage container 46 is connected to the carrier mechanism 12 via a container carrier 48.

The carrier mechanism 12 allows the relative position of the fertilizer-depositing device 22 and the seed-depositing device 34 to be changed by means of the deflection mechanism 18 and the deflection mechanism 30.

The distributing unit 10 comprises a position-detecting system 52, 54, by means of which the relative position, influencing the longitudinal distance of the fertilizer deposited on the agricultural land and the seed deposited on the agricultural land, between the fertilizer-depositing device 22 and the seed-depositing device 34 can be detected sensor-based. The position-detecting system comprises a sensor 54 and an electronic data-processing device 52, wherein the electronic data-processing device 52 evaluates the sensor data of the sensor for detecting the relative position between the fertilizer-depositing device and the seed-depositing device 34. The carrier mechanism 12 allows the longitudinal distance x between the fertilizer-dispensing opening 28 and the seed-dispensing opening 40 to be changed. The relative position detected by the position-detecting system 52, 54 between the fertilizer-depositing device 22 and the seed-depositing device 34 relates to the longitudinal distance x between the fertilizer-dispensing opening 28 and the seed-dispensing opening 40. Since the fertilizer-dispensing opening 28 determines the dispensing point of the fertilizer and the seed-dispensing opening 40 determines the dispensing point of the seed, the longitudinal distance of the fertilizer and seed deposited on the agricultural land can be determined from the longitudinal distance between the fertilizer-dispensing opening 28 and the seed-dispensing opening 40.

The sensor 54 is arranged in the articulation between the links 20a, 20b of the deflection mechanism 18 and is used for detection of the deflection state of the deflection mechanism 18 influencing the fertilizer deposition. The sensor 54 is configured as an angle sensor and detects the angle between the links 20a, 20b. The electronic data-processing device 52 calculates the longitudinal distance x between the fertilizer-dispensing opening 28 and the seed-dispensing opening 40 on the basis of the deflection state of the deflection mechanism 18 influencing the fertilizer deposition. The deflection mechanism 18 influencing the fertilizer deposition and the deflection mechanism 30 influencing the seed deposition are mechanically coupled to one another via a coupling rod 58. The coupling rod 58 is articulated on the lower link 32b of the deflection mechanism 30 and the link 20b of the deflection mechanism 18.

If the data-processing device 52 determines that the longitudinal distance x is outside a tolerance range due to a deflection of the fertilizer-depositing device 22 and/or due to a deflection of the seed-depositing device 34, so that the longitudinal distance x results in an unintended relative position between fertilizer and seed on the agricultural land, the operation of the fertilizer-metering device and/or the operation of the seed-metering device 44 can be adapted by means of a control device 50. By adjusting the operation of the fertilizer-metering device and/or the seed-metering device, the dispensing times of the fertilizer portions produced and/or the separated seeds can be temporarily adjusted so that the fertilizer and seed deposition are synchronized again by dispensing the fertilizer and seed at coordinated times. For this purpose, for example, the speed of a rotatory driven portioning element, for example a portioning wing, of the fertilizer-metering device and/or the speed of a separating element, for example a separating disc, of the seed-metering device 44 can be temporarily adapted.

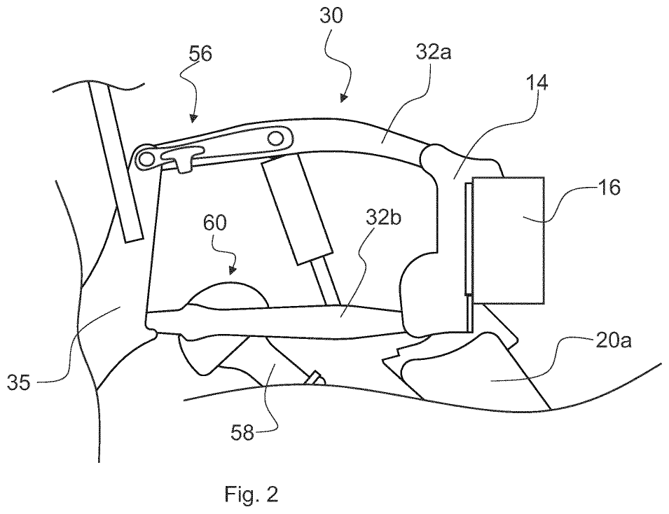

FIG. 2 shows that the position-detecting system can alternatively or additionally comprise a sensor 56 on the deflection mechanism 30, in addition to the sensor 54 on the deflection mechanism 18. The sensor 56 serves to detect the deflection state of the deflection mechanism 30. The deflection state of the deflection mechanism 30 is detected by the sensor 56 via the alignment of the upper link 32a.

The electronic data-processing device 52 then also calculates the longitudinal distance x between the fertilizer-dispensing opening 28 and the seed-dispensing opening 40 on the basis of the deflection state of the deflection mechanism 30 influencing the seed deposition. The position-detecting system can comprise either one of the sensors 54, 56 or both sensors 54, 56.

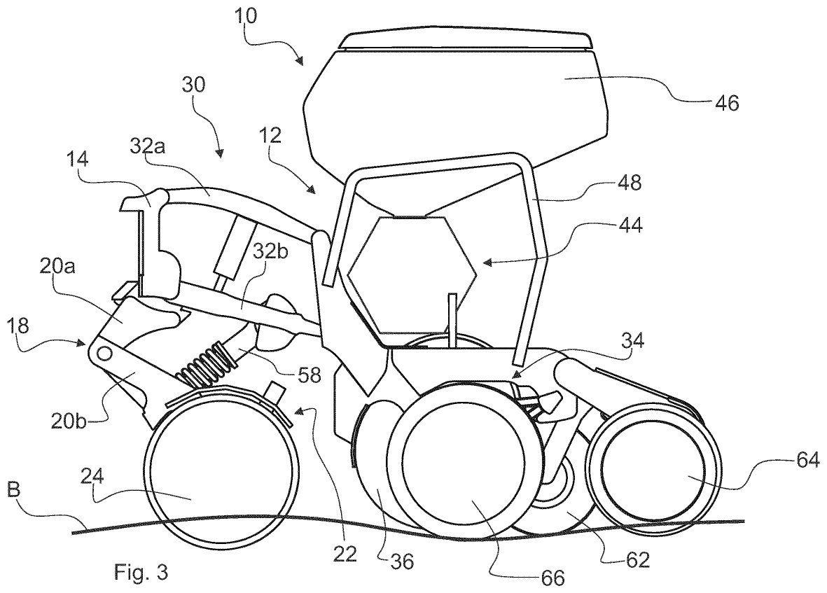

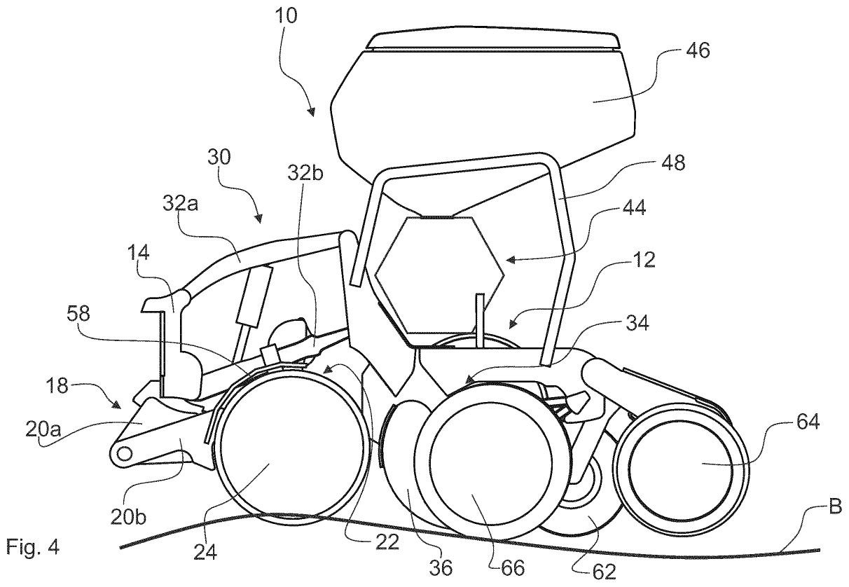

FIGS. 3 and 4 show the kinematic coupling of deflection mechanism 18 and of the deflection mechanism 30 via the coupling rod 58.

The distributing unit 10 comprises a depth guide roller 66, which is arranged laterally next to the seed-depositing device 34. Behind the coulter discs 36 of the seed-depositing device 34 is a catching roller 62 for catching the deposited seed and V-shaped pressure rollers 64 for closing the seed furrow.

In the distribution situation shown in FIG. 3, the depth guide roller 66 passes over a hollow, so that the seed-depositing device 34 is deflected downwards with respect to the attachment part 14 by means of the deflection mechanism 30. The deflection of the deflection mechanism 30 also influences the deflection state of the deflection mechanism 18 influencing the fertilizer deposition via the coupling rod 58, so that, despite the lack of a depth control roller on the fertilizer-depositing device 22, the fertilizer-depositing device 22 is guided in a manner specific to the ground contours.

In the distribution state shown in FIG. 4, the depth guide roller 66 passes over a crest, so that the seed-depositing device 34 is deflected upwards with respect to the attachment part 14 by means of the deflection mechanism 30. Via the coupling rod 58, this deflection also influences the deflection state of the deflection mechanism 18 influencing the fertilizer deposition, so that the fertilizer-depositing device 22 is again guided in a manner specific to the ground contours.

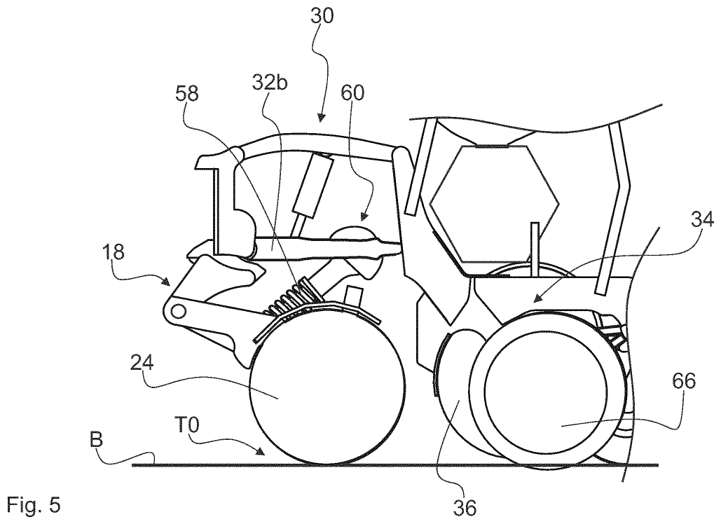

FIGS. 5 to 7 show that the deposition depth of the fertilizer can be changed via an adjusting element 60. The adjusting element 60 is configured as an eccentric and connects the lower link 32a of the deflection mechanism 30 to the coupling rod 58. The upper articulation point of the coupling rod 58 can be changed by means of the adjusting element 60, so that the distance between the coulter discs 24 of the fertilizer-depositing device 22 and the deflection mechanism 30 can be changed. In the setting shown in FIG. 5, a minimum fertilizer-depositing depth T₀ is set.

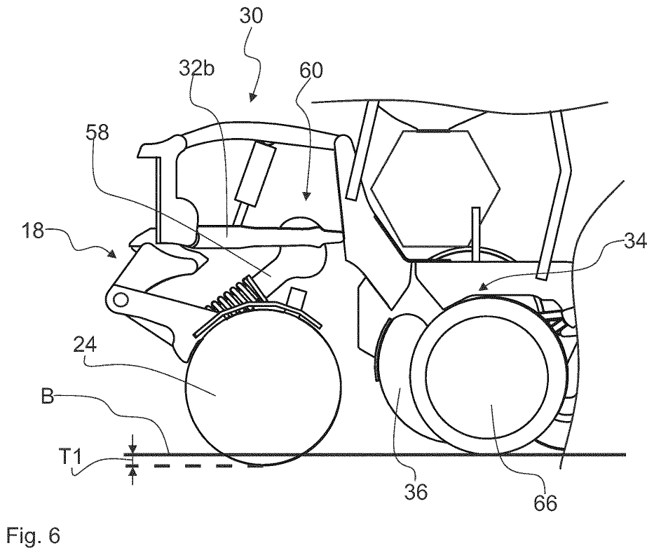

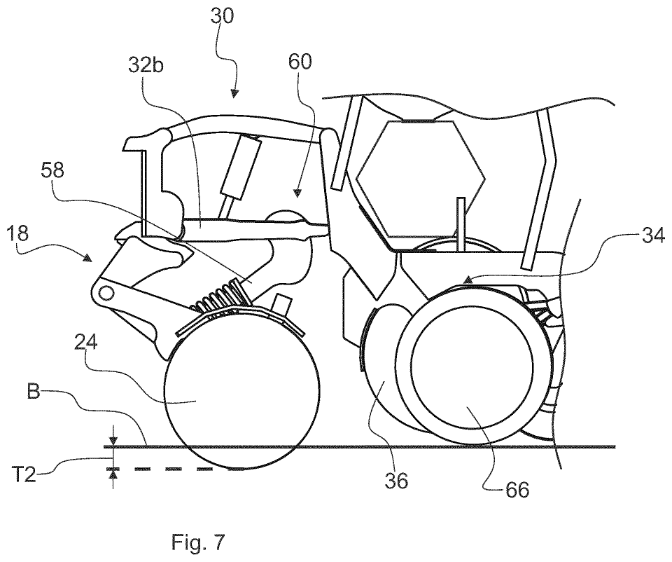

By twisting the eccentric setting element 60, the fertilizer-depositing depth can be adjusted to the dimension T₁, as shown in FIG. 6. Further twisting of the eccentric setting element 60 results in a further increase in the fertilizer-depositing depth to the dimension T₂, as shown in FIG. 7.

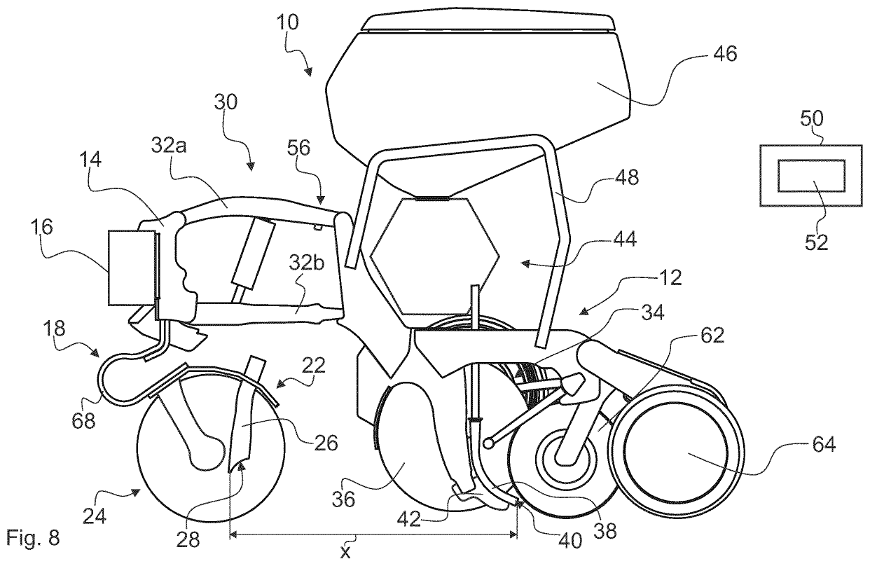

FIG. 8 shows a distributing unit 10 in which the deflection mechanism 18 influencing the fertilizer deposition comprises a suspension 68 configured as a leaf suspension.

The distributing unit 10 comprises a position-detecting system 52, 56 for the sensor-based detection of the relative position between the fertilizer-depositing device 22 and the seed-depositing device 34, which influences the longitudinal distance of the fertilizer deposited on the agricultural land and the seed deposited on the agricultural land.

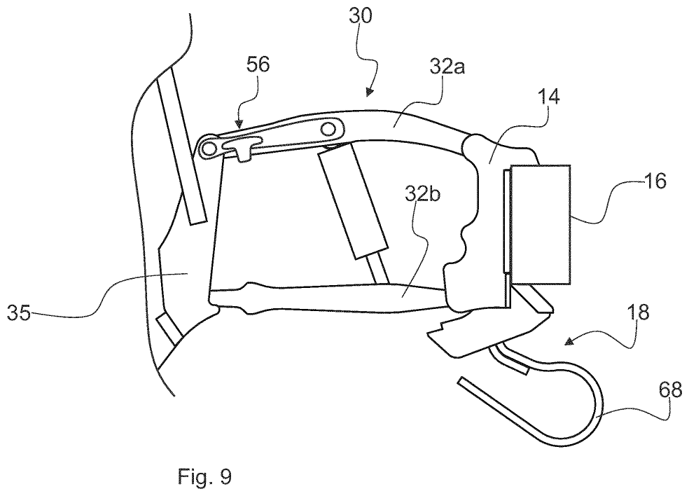

As shown in FIG. 9, the sensor 56 of the position-detecting system is arranged on the upper link 32a of the deflection mechanism 30, so that the deflection state of the deflection mechanism 30 can be determined via the alignment of the upper link 32.

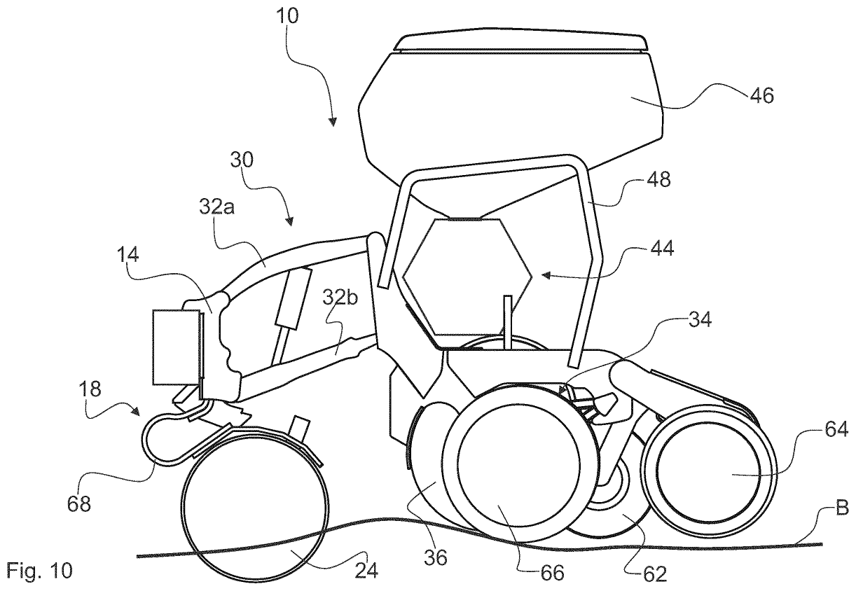

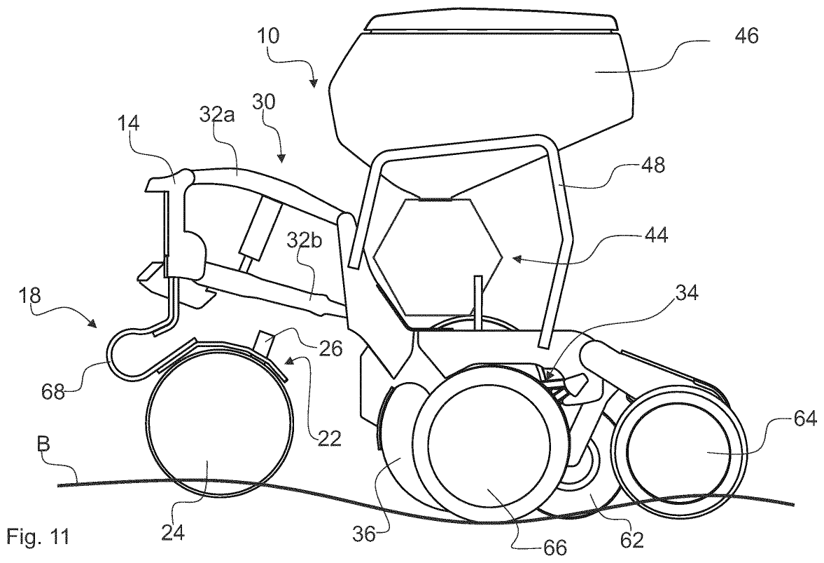

FIGS. 10 and 11 show that it is also possible for the fertilizer-depositing device 22 to follow the contour of the ground B via the leaf suspension 68 between the attachment part 14 and the fertilizer-depositing device 22. In this respect, a suitable fertilizer-depositing depth can be maintained when driving over a crest (see FIG. 10) and when driving over a hollow (see FIG. 11).

### REFERENCE SIGNS

10 distributing unit
12 carrier mechanism
14 attachment part
16 unit carrier
18 deflection mechanism
20a, 20b link
22 fertilizer-depositing device
24 coulter discs
26 fertilizer-depositing line
28 fertilizer-dispensing opening
30 deflection mechanism
32a, 32b link
34 seed-depositing device
35 carrier part
36 coulter discs
38 seed-depositing line
40 seed-dispensing opening
42 furrow former
44 seed-metering device
46 storage container
48 container carrier
50 control device
52 data-processing device
54 sensor
56 sensor
58 coupling rod
60 adjusting element
62 catching roller
64 pressure rollers
66 depth guide roller
68 suspension
B ground
T₀, T₁, T₂ depositing depths
x longitudinal distance

1. A distributing unit for an agricultural distributor, comprising:
a fertilizer-depositing device for depositing fertilizer on agricultural land; and
a seed-depositing device for depositing seed on the agricultural land;
wherein the fertilizer-depositing device and the seed-depositing device are fastened on a carrier mechanism, and the carrier mechanism allows a change in relative position between the fertilizer-depositing device and the seed-depositing device; wherein a position-detecting system which is adapted to sensor-based detect a relative position between the fertilizer-depositing device and the seed-depositing device which influences the longitudinal distance of the fertilizer deposited on the agricultural land and the seed deposited on the agricultural land.

2. The distributing unit according to claim 1, wherein the position-detecting system has at least one sensor and an electronic data-processing device, wherein the electronic data-processing device is adapted to evaluate sensor data from the sensor for detection of the relative position between the fertilizer-depositing device and the seed-depositing device.

3. The distributing unit according to claim 1, wherein
the fertilizer-depositing device has a fertilizer-dispensing opening for dispensing fertilizer in the direction of the ground of the agricultural land; and
the seed-depositing device has a seed-dispensing opening for dispensing seeds in the direction of the ground of the agricultural land;
wherein the carrier mechanism allows the longitudinal distance between the fertilizer-dispensing opening and the seed-dispensing opening to be changed and the relative position between the fertilizer-depositing device and the seed-depositing device, which can be sensor-based detected by the position-detecting system comprises the longitudinal distance between the fertilizer-dispensing opening and the seed-dispensing opening.

4. The distributing unit according to claim 1, wherein the carrier mechanism allows a change in alignment of the fertilizer-depositing device, wherein the relative position between the fertilizer-depositing device and the seed-depositing device comprises the alignment of the fertilizer-depositing device and/or a relative alignment of the fertilizer-depositing device and the seed-depositing device.

5. The distributing unit according to claim 1, wherein the carrier mechanism has an attachment part by which the carrier mechanism can be fastened on a unit carrier, in particular a cross beam, of the agricultural distributor,
wherein the carrier mechanism preferably comprises a deflection mechanism influencing seed deposition, by which the seed-depositing device can be deflected with respect to the attachment part of the carrier mechanism, in particular for following the ground contour of the agricultural land.

6. The distributing unit according to claim 5, wherein at least one sensor of the position-detecting system is adapted to detect a deflection state of the deflection mechanism influencing the seed deposition.

7. The distributing unit according to claim 5,
wherein the carrier mechanism comprises a deflection mechanism that influences fertilizer deposition, by which the fertilizer-depositing device can be deflected with respect to the attachment part of the carrier mechanism for following the ground contour of the agricultural land.

8. The distributing unit according to claim 7, wherein at least one sensor of the position-detecting system is configured to detect a deflection state of the deflection mechanism in order to influence the fertilizer deposition.

9. The distributing unit according to claim 7, wherein the deflection mechanism influences the seed deposition and the deflection mechanism influences the fertilizer deposition are mechanically coupled to one another.

10. The distributing unit according to claim 7, wherein the deflection mechanism comprises a suspension, in particular a leaf suspension.

11. The distributing unit according to claim 1, wherein the position-detecting system is configured to calculate a smooth-running value which characterizes the smooth running of the fertilizer-depositing device on the basis of changes in the position of the fertilizer-depositing device determined over a period of time and/or on the basis of the relative positions of the fertilizer-depositing device and the seed-depositing device determined over a period of time.

12. The distributing unit according to claim 1, further comprising:
a fertilizer-metering device configured to adapt to meter the fertilizer to be despoisited,
a seed-metering device (44) configured to meter the seed to be deposited, and
a control device which is configured to:
control operation of the fertilizer-metering device as a function of the relative position between the fertilizer-depositing device and the seed-depositing device (34); relative positon between the fertilizer-depositing device and the seed-depositing device,
control operation of the seed-metering device as a function of the relative position between the fertilizer-depositing device and the seed-depositing device; or
coordinate the operation of the fertilizer-metering device and the operation of the seed-metering device with each other, as a function of the relative position between the fertilizer-depositing device and the seed-depositing device.

13. The distributing unit according to claim 12, wherein
the fertilizer-depositing device comprises a fertilizer-depositing line or the fertilizer-dispensing opening; or
the seed-depositing device comprises a seed-depositing line or the seed-dispensing opening,
wherein the control device is configured to:
control a positioning drive to change a position of the fertilizer-dispensing opening or the alignment of the fertilizer-depositing line as a function of the relative position between the fertilizer-depositing device and the seed-depositing device; or
control a positioning drive to change the position of the seed-dispensing opening or the alignment of the seed-depositing line as a function of the relative position between the fertilizer-depositing device and the seed-depositing device.

14. A method for operating the distributing unit set forth in claim 12 comprising:
detecting a changeable relative position between the fertilizer-depositing device and the seed-depositing device by using a position-detecting system;
using the control device to control operation of a fertilizer-metering device of the distributing unit, which is adapted to meter, fertilizer to be deposited, or
using the control device to control operation of a seed-metering device of the distributing unit, which is adapted to meter seed to be deposited, as a function of a detected relative position between the fertilizer-depositing device and the seed-depositing device.

15. The method according to claim 14, wherein the control device:
controls a positioning drive of the distributing unit to change a position of a fertilizer-dispensing opening of the distributing unit, the alignment of a fertilizer-depositing line of the distributing unit; or
controls a positioning drive of the distributing unit to change a position of a seed-dispensing opening of the distributing unit and/or alignment of a seed-depositing line of the distributing unit as a function of the detected relative position between the fertilizer-depositing device and the seed-depositing device.
